(19) United States
(12) Patent Application Publication
(10) Pub. No.: US 2025/0023434 A1
(43) Pub. Date: Jan. 16, 2025

(54) METHOD OF DESIGNING A MOTOR HAVING POLYCRYSTALLINE DIAMOND-ON-METAL BEARINGS

(71) Applicant: XR Reserve, LLC, Houston, TX (US)

(72) Inventors: Gregory Prevost, Spring, TX (US); Edward C. Spatz, Spring, TX (US); William W. King, Houston, TX (US)

(73) Assignee: XR Reserve, LLC, Houston, TX (US)

(21) Appl. No.: 18/767,692

(22) Filed: Jul. 9, 2024

Related U.S. Application Data
(60) Provisional application No. 63/513,072, filed on Jul. 11, 2023.

(51) Int. Cl. H02K 15/00; H02K 7/08

(52) U.S. Cl. CPC H02K 15/00; H02K 7/08; H02K 2215/00

(57) ABSTRACT

Methods of designing downhole drilling motors are disclosed herein. The method is iterative, allowing for a custom drilling motor to be designed based on client and application specific needs.

### CROSS-REFERENCE TO RELATED APPLICATIONS

The present application claims the benefit of U.S. Provisional Patent Application No. 63/513,072 (pending), having a filing date of Jul. 11, 2023, and entitled “Method of Designing a Motor Having Polycrystalline Diamond-on-Metal Bearings,” the entirety of which is incorporated herein by reference.

### FIELD

The present disclosure relates to methods of designing a motor having polycrystalline diamond bearing surfaces engaged with metal bearing surfaces.

### BACKGROUND

Motors are employed in myriad applications including, but not limited to downhole drilling (e.g., oil and gas drilling). Bearings in motors can have many different configurations, such as radial bearings, axial bearings (e.g., thrust bearings), and combination radial and axial bearings. Polycrystalline diamond bearing elements that are in sliding contact with certain metals, including at cryogenic environmental temperatures, have a potential for relatively high localized temperatures (relative to the low-temperature of the surrounding environment) that can lead to graphitization of the diamond material. When diamond elements are used in moving parts, typically both the engagement surface and the opposing engagement surface of the bearing assembly are composed of polycrystalline diamond. This is, at least in part, because polycrystalline diamond, including thermally stable polycrystalline diamond (TSP), either supported or unsupported by tungsten carbide, and polycrystalline diamond compact (PDC) have been considered as contraindicated for use in the machining of diamond reactive materials. At certain surface speeds in moving parts, load and attendant temperature generated, such as at a cutting tip, often exceeds the graphitization temperature of diamond (i.e., about 700° C.), which can, in the presence of a diamond reactive material, lead to rapid wear and failure of components. The specific failure mechanism is believed to result from the chemical interaction of the carbon bearing diamond with the carbon attracting material that is being machined. An exemplary reference concerning the contraindication of diamond for diamond reactive material machining is U.S. Pat. No. 3,745,623. The contraindication of diamond for machining diamond reactive material has long caused the avoidance of the use of diamond in all contacting applications with such materials.

Current processes for designing drilling motors provide for a directional drilling company to select a bend angle for a motor but little, if anything, else. However, other variables of drilling motors, in addition to bend angle, may affect the suitability of a motor to a particular project, such as the power section, transmission section, and bearing section of the motor. It would be desirable for directional drilling companies to be able to select additional features of a motor.

### BRIEF SUMMARY

Some embodiments of the present disclosure include a method for designing a motor. The method includes determining an application for the motor, determining a type of power section for the motor, determining a transmission type for the motor, determining a type bearing for use in the motor, reviewing connection threads and stresses in the motor, and locking-in a bit-to-bend length for the motor.

Some embodiments of the present disclosure include a motor designed in accordance with the methods disclosed herein.

### BRIEF DESCRIPTION OF THE DRAWINGS

So that the manner in which the features and advantages of the systems and methods of the present disclosure may be understood in more detail, a more particular description briefly summarized above may be had by reference to the embodiments thereof which are illustrated in the appended drawings that form a part of this specification. It is to be noted, however, that the drawings illustrate only various exemplary embodiments and are therefore not to be considered limiting of the disclosed concepts as it may include other effective embodiments as well.

FIG. 1A is a portion of a flow chart showing steps of a method of designing a motor in accordance with embodiments of the present disclosure.

FIG. 1B is a continuation of the flow chart of FIG. 1A showing additional steps of the method of designing a motor in accordance with embodiments of the present disclosure.

FIG. 1C is a continuation of the flow chart of FIG. 1B showing additional steps of the method of designing a motor in accordance with embodiments of the present disclosure.

### DETAILED DESCRIPTION

### Motor Design

Embodiments of the present disclosure include methods of designing motors for applications, such as for use in downhole drilling applications including directional drilling applications. The methods can be implemented to design a custom, bespoke motor for a particular client and/or a particular application.

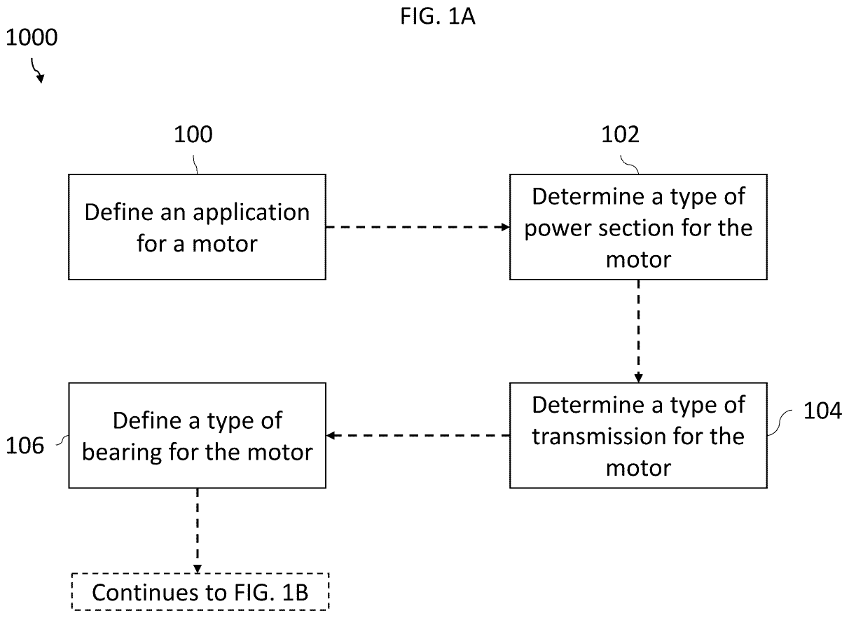

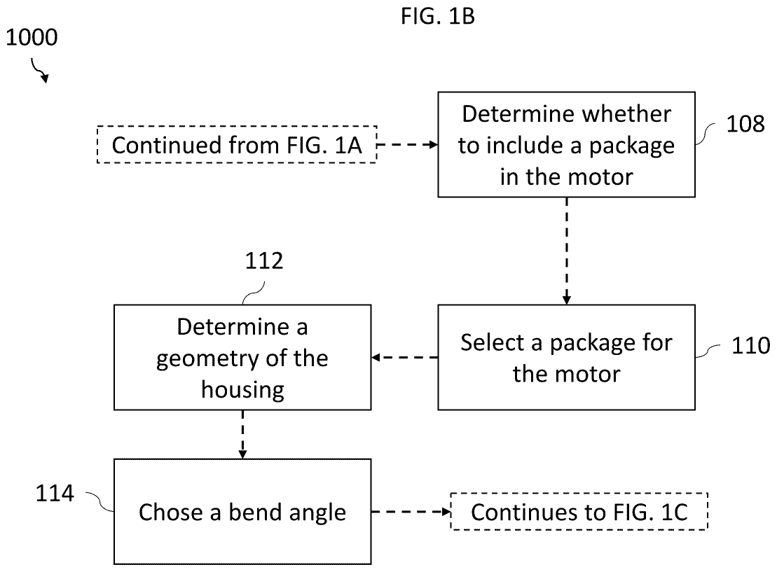

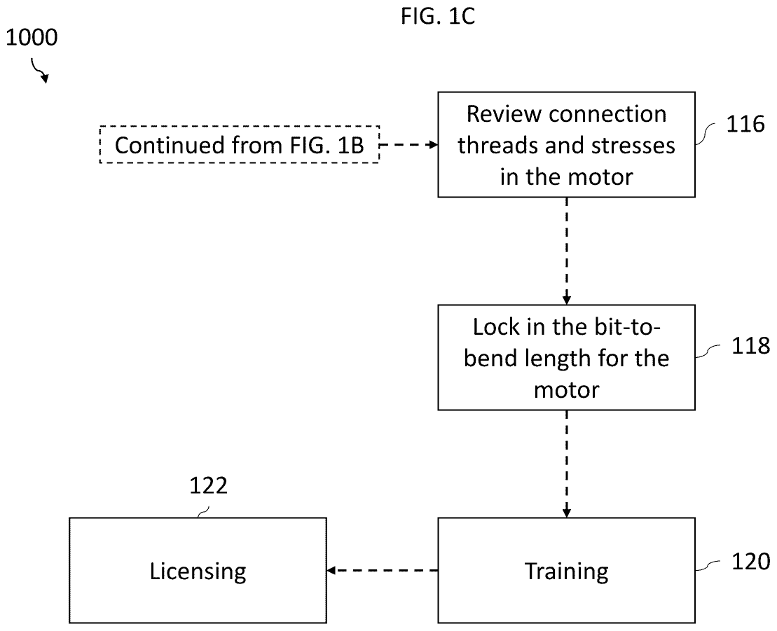

With reference to FIGS. 1A-1C, motor design method 1000 includes defining an application for the motor, step 100. Defining the application may include determining a motor type, including determining whether the motor will be a motor assist rotary steerable type motor or a bent housing directional drilling type motor.

Motor design method 1000 includes determining a type of power section for the motor, step 102. Determining a type of power section can include determining whether the power section will be a high-speed/low-torque power section or a low-speed/high-torque power section.

Motor design method 1000 includes determining a transmission type for the motor, step 104. Determining a type of transmission can include determining whether the transmission will include a flex shaft or mechanical coupling, including determining whether a flex shaft is titanium or steel or determining whether a mechanical coupling is a standard coupling or a diamond-on-metal coupling. The transmission can be selected to be suitable for expected torques and loads on the motor. In some embodiments, the transmission is selected to include a transmission or driveline in accordance with U.S. Pat. No. 11,054,000; U.S. Patent Publication No. US/2022/0136585; or U.S. Pat. No. 11,614,126; each of which are incorporated herein by reference in their entireties.

Motor design method 1000 includes defining a type bearing for use in the motor, step 106. The bearing can be a diamond-on-metal bearing or another bearing arrangement. Defining the type bearing can include determining the bearing to be in the configuration of a conical bearing assembly, a conical plus radial bearing assembly, or an axial drop-in bearing assembly. The bearings can be determined to include a cam and cam follower, such as is disclosed in U.S. Pat. No. 10,465,775; a radial bearing or combined radial and axial bearing, such as is disclosed in U.S. Pat. No. 10,738,821; a thrust bearing such as is disclosed in U.S. Pat. No. 10,760,615; a bearing with a treated surface as is disclosed in U.S. Pat. No. 11,035,407; a bearing such as those disclosed in U.S. Pat. No. 11,187,040; a compliant bearing such as those disclosed in U.S. Pat. No. 11,286,985; a bearing such as those disclosed in U.S. Pat. No. 11,655,850; a bearing such as those disclosed in U.S. Patent Publication No. US/2022/0145934; a bearing such as those disclosed in U.S. patent application Ser. No. 18/299,399; a bearing mounted in accordance with the threaded connections disclosed in U.S. Patent Publication No. US/2020/0355213; or a combination thereof. The entireties of each of U.S. Pat. Nos. 10,465,775; 10,738,821; 10,760,615; 11,035,407; 11,187,040; 11,286,985; 11,655,850; U.S. Patent Publication No. US/2022/0145934; U.S. patent application Ser. No. 18/299,399; and U.S. Patent Publication No. US/2020/0355213 are incorporated herein by reference and made a part of the present disclosure.

Motor design method 1000 includes determining whether to include a sensor package, a communications package, an actuator package, or any combination thereof in the motor, step 108.

If a sensor package, communications package, actuator package, or any combination thereof is determined to be included in step 108, the motor design method 1000 includes selecting a sensor package, communications package, actuator package, or a combination thereof to include in the motor, step 110. Step 110 can include choosing the type, combination, and/or components of such a package, as well as choosing a location for the package. In some embodiments where a sensor package, communications package, actuator package, or a combination thereof is included in the motor, the type of bearing defined in step 106 will be a conical bearing. The sensor package, communications package, actuator package, or a combination thereof may be any such package of downhole components as is disclosed in incorporated U.S. Pat. No. 11,187,040.

The motor design method 1000 is iterative, and prior steps in the method affect the available options of subsequent steps. The motor design method 1000 includes optionally revisiting prior steps in view of the effects those prior steps have on the available options of subsequent steps. For example, if it desired to position the package in or on the bearing housing (e.g., between two spaced apart bearing arrays) and the design configuration at step 108 does not allow for such a positioning of the package, then the method can include reverting back to sept 106 to select the bearing to be a diamond-on-metal bearing (e.g., if the bearing was previously selected to be a diamond-on-diamond bearing). The diamond-on-metal bearings require less space of the bearing housing to be dedicated to the bearing elements than would otherwise be required in other bearings (e.g., diamond-on-diamond bearings) such that additional available space of the bearing housing can be used to position downhole components as disclosed in incorporated U.S. Pat. No. 11,187,040. The ability to position the package in the housing can reduce the bit-to-bend length by eliminating the need to position the package below the bearings housing.

If the motor will be used in an application with a bent housing, as determined in step 100, then the motor design method 1000 includes determining a geometry of the housing, step 112. Determining the geometry can include choosing standard, compound geometric guidance positioners, choosing a dynamic lateral pad, or choosing a combination thereof. The geometry can be determined in order to reduce the bend angle of the housing. The motor can be designed to have pads in accordance with U.S. Pat. No. 10,626,674; guidance positioning members in accordance with U.S. Pat. No. 11,255,136; or positioners in accordance with U.S. Patent Publication No. US/2021/0246727 and U.S. Pat. No. 10,890,030. In some embodiments, the motor is designed to include features of the drilling apparatus disclosed in U.S. Pat. No. 10,662,711. In some embodiments, the motor is designed to include design features disclosed in Design Pat. No. D874234; Design Pat. No. D920070; Design Pat. No. D874235; Design Pat. No. D919397; Design Pat. No. D874236; Design Pat. No. D920071; Design Pat. No. D874237; Design Patent No. D920072; Design Pat. No. D863919; Design Pat. No. D889231; Design Pat. No. D877780; Design Pat. No. D875144; Design Pat. No. D875145; or Design Pat. No. D875146; the entireties of each of which are incorporated herein by reference.

If the motor will be used in an application with a bent housing, as determined in step 100, then the motor design method 1000 includes choosing a bend angle, step 114. For example, and without limitation, choosing a bend angle can include choosing no angle, choosing a standard angle, choosing a low-bend angle, or choosing a micro-bend angle. If the bend angle is too high or otherwise undesirable, then the method can include reverting to prior steps to reconfigure the motor such that a more desirable bend angle can be achieved.

The motor design method 1000 includes reviewing connection threads and stresses in the motor, step 116.

The motor design method 1000 includes locking-in the bit-to-bend length for the motor, step 118. Step 118 can include determining if the bit-to-bend length is appropriate for the expected or desired build angle. If the bit-to-bend length is not appropriate, then the method can include reverting to prior steps to reconfigure the motor such that a more desirable bit-to-bend length can be achieved.

Some embodiments of the method include a training step, step 120. Step 120 can include training field engineering personnel to implement the motor design method. For example, a motor design engineer can work with a drilling company to determine a custom motor design for that particular drilling company and/or the particular drilling project. This allows the drilling company to obtain a bespoke drilling motor, as opposed to merely selecting a bend angle of an otherwise OEM drilling motor. The method can include a licensing step, step 122. Step 122 can include the motor design engineer offering a custom batch of license agreements to cover any of the desired technology available at each step of the method.

In some embodiments, at least some of the steps disclosed herein are implemented utilizing computer modeling or other modeling of the motor. The modeling of the motor can account for the bearings, expected bearing loads, distance between upper and lower bearings (e.g., indicating how much space, if any, exists for positioning a component package in the bearing housing), threads on housing and level of stress on threads, bit-to-bend length, bend angle and other factors.

Each step at least partially affects subsequent steps, such as by restraining the available options of a subsequent step. Thus, the method disclosed herein is iterative, such that prior steps can be revisited as needed to resolve an issue with a current step. Furthermore, some steps can be added to the above exemplary steps, some steps can be removed from the above exemplary steps, and the order of some of the steps can be rearranged. An exemplary iterative design process for designing a drilling system is disclosed in U.S. Pat. No. 6,612,382.

### Diamond Bearing Surfaces

The motors disclosed herein are designed to include a polycrystalline diamond bearing element having a polycrystalline diamond engagement surface (also referred to as a polycrystalline diamond bearing surface) engaged with an opposing bearing element having an opposing metal engagement surface (also referred to as an opposing bearing surface). The polycrystalline diamond (PCD) may be or include TSP diamond, either supported or unsupported by a support, such as a tungsten carbide support. The polycrystalline diamond may be or include a PDC. In certain applications, the polycrystalline diamond disclosed herein has increased cobalt content transitions layers between an outer polycrystalline diamond surface and a supporting tungsten carbide slug. The polycrystalline diamond may be non-leached, leached, leached and backfilled, thermally stable, or coated with a material, such as via chemical vapor deposition (CVD). In some embodiments, the polycrystalline diamond is formed via a CVD process. Throughout the descriptions of the embodiments in this disclosure, for the sake of brevity and simplicity, “diamond” is used to refer to “polycrystalline diamond.” That is, the “diamond bearing surfaces” disclosed herein are “polycrystalline diamond bearing surfaces” and the “diamond bearing elements” are “polycrystalline diamond bearing elements.”

In some embodiments, the bearing assemblies disclosed herein include only a single polycrystalline diamond bearing element. In other embodiments, the bearing assemblies disclosed herein include a plurality of discrete polycrystalline diamond bearing elements. The plurality of discrete polycrystalline diamond bearing elements can be arranged in a spaced-apart configuration in the bearing assembly.

In certain applications, the diamond, or at least the engagement surface thereof, is lapped or polished, optionally highly lapped or highly polished. As used herein, a surface is defined as “highly lapped” if the surface has a surface roughness of about 20 μin Ra, such as a surface roughness ranging from about 18 to about 22 μin Ra. As used herein, a surface is defined as “polished” if the surface has a surface roughness of from about 2 to about 10 pin Ra. As used herein, a surface is defined as “highly polished” if the surface has a surface roughness of less than 2 μin Ra, such as a surface roughness of from about 0.5 μin to less than about 2 μin Ra.

In some aspects, the diamond bearing surfaces disclosed herein have a surface roughness ranging from 0.5 μin Ra to 20 μin Ra, or from 2 pin Ra to 18 pin Ra, or from 5 μin Ra to 15 pin Ra, or from 8 μin Ra to 12 μin Ra, or less than 20 pin Ra, or less than 18 μin Ra, or less than 10 μin Ra, or less than 2 μin Ra, or any range or discrete value therebetween. Without being bound by theory, it is believed that diamond that has been polished to a surface roughness of 0.5 μin Ra has a coefficient of friction that is less than (e.g., about half or more than half) of standard lapped diamond that has a surface roughness of 20-40 μin Ra. As would be understood by one skilled in the art, surface finish, also referred to as surface texture or surface topography, is a characteristic of a surface as defined by lay, surface roughness, and waviness. As would be understood by one skilled in the art, the surface roughness Ra is a “roughness average.” Surface finish may be determined in accordance with ASME B46.1-2019. Surface finish or roughness may be measured with a profilometer, laser microscope, or with Atomic Force Microscopy, for example.

### Metal Bearing Surface

The motors disclosed herein are designed to include an opposing bearing element that includes a metal bearing surface. The metal bearing surface includes a metal that is a diamond reactive material. As used herein, a metal that is a “diamond reactive material” is a metal that contains more than trace amounts of diamond solvent-catalyst (also referred to as a diamond catalyst-solvent, diamond solvent, or diamond catalyst). As used herein, a metal that contains more than “trace amounts” of diamond solvent-catalyst is a metal that contains at least 2 percent by weight (wt. %) diamond solvent-catalyst based on a total weight of the metal. Some examples of known diamond solvent-catalysts are disclosed in: U.S. Pat. Nos. 6,655,845; 3,745,623; 7,198,043; 8,627,904; 5,385,715; 8,485,284; 6,814,775; 5,271,749; 5,948,541; 4,906,528; 7,737,377; 5,011,515; 3,650,714; 2,947,609; and 8,764,295. As would be understood by one skilled in the art, diamond solvent-catalysts are chemical elements, compounds, or materials (e.g., metals) that are capable of catalyzing the formation of diamond, such as by promoting intercrystallite diamond-to-diamond bonding between diamond grains to form a polycrystalline diamond. As would be understood by one skilled in the art, diamond solvent-catalysts are chemical elements, compounds, or materials (e.g., metals) that are capable of solubilizing polycrystalline diamond by catalyzing the reaction of the diamond into graphite, such as under load and at a temperature at or exceeding the graphitization temperature of diamond. Diamond solvent-catalysts are capable of catalyzing the graphitization of diamond (e.g., polycrystalline diamond), such as when under load and at a temperature at or exceeding the graphitization temperature of the diamond (e.g., about 700° C.). Diamond reactive materials include, but are not limited to, metals including metal alloys that contain more than trace amounts of diamond solvent-catalysts. Some exemplary diamond solvent-catalysts include iron, cobalt, nickel, ruthenium, rhodium, palladium, chromium, manganese, copper, titanium, and tantalum. Thus, a diamond reactive material can be a metal that includes more than trace amounts of iron, cobalt, nickel, ruthenium, rhodium, palladium, chromium, manganese, copper, titanium, and tantalum, or combinations thereof. One exemplary diamond reactive material is steel.

The diamond reactive material disclosed herein may be a metal or metal alloy (collectively referred to herein as a “metal” or a “metallic material”) having a metal surface. As would be understood by one skilled in the art, metals include materials that contain metal atoms that are typically characterized by metallic bonding between the metal atoms. That is, metals can be characterized as having metal atoms that are chemically bonded together, with at least predominantly metallic bonding between the metal atoms (e.g., in a crystalline structure of the metal atoms). The metals disclosed herein are not ceramics (e.g., carbides, oxides, nitrides, natural diamond), plastics, or composites (e.g., ceramic matrix composites or metal matrix composites, such as cermets, cemented carbide cobalt composites, PCD cobalt binder composites, CBN cobalt binder composites). In some embodiments the metal is a metal alloy. In other embodiments the metal is not a metal alloy (i.e., contains a single metal). The metal may be ferrous or a ferrous alloy. For example, the metal may be iron or an iron alloy, such as cast iron or steel, such as stainless steel, carbon steel, tool steel, or alloy steels. The metal may be non-ferrous or a non-ferrous alloy. For example, the metal may be nickel or a nickel alloy, cobalt or a cobalt alloy, copper or a copper alloy, titanium or a titanium alloy, ruthenium or a ruthenium alloy, rhodium or a rhodium alloy, palladium or a palladium alloy, chrome or a chrome alloy, manganese or a manganese alloy, or tantalum or a tantalum alloy.

The opposing bearing surface may include a metal that contains at least 2 wt. % of a diamond solvent-catalyst based on a total weight of the metal. In some embodiments, the opposing bearing surface is or includes a metal that contains from 2 to 100 wt. %, or from 5 to 95 wt. %, or from 10 to 90 wt. %, or from 15 to 85 wt. %, or from 20 to 80 wt. %, or from 25 to 75 wt. %, or from 25 to 70 wt. %, or from 30 to 65 wt. %, or from 35 to 60 wt. %, or from 40 to 55 wt. %, or from 45 to 50 wt. % of diamond solvent-catalyst based on a total weight of the metal, or any range or discrete value therebetween. In some embodiments, the opposing bearing surface is or includes a metal that contains at least 3 wt. %, or at least 5 wt. %, or at least 10 wt. %, or at least 15 wt. %, or at least 20 wt. %, or at least 25 wt. %, or at least 30 wt. %, or at least 35 wt. %, or at least 40 wt. %, or at least 45 wt. %, or at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 95 wt. %, or at least 99 wt. %, or 100 wt. % of diamond solvent-catalyst based on a total weight of the metal. In some embodiments, an entirety of the opposing bearing surface is a diamond reactive material.

In some embodiments, the diamond reactive materials disclosed herein contain from 2 to 100 wt. %, or from 5 to 95 wt. %, or from 10 to 90 wt. %, or from 15 to 85 wt. %, or from 20 to 80 wt. %, or from 25 to 75 wt. %, or from 25 to 70 wt. %, or from 30 to 65 wt. %, or from 35 to 60 wt. %, or from 40 to 55 wt. %, or from 45 to 50 wt. % of metal based on a total weight of the diamond reactive material, or any discrete value or range therebetween. In some embodiments, the diamond reactive materials disclosed herein contain at least 3 wt. %, or at least 5 wt. %, or at least 10 wt. %, or at least 15 wt. %, or at least 20 wt. %, or at least 25 wt. %, or at least 30 wt. %, or at least 35 wt. %, or at least 40 wt. %, or at least 45 wt. %, or at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 95 wt. %, or at least 99 wt. %, or 100 wt. % of metal based on a total weight of the diamond reactive material.

In some embodiments, the diamond reactive materials disclosed herein contain from 2 to 100 wt. %, or from 5 to 95 wt. %, or from 10 to 90 wt. %, or from 15 to 85 wt. %, or from 20 to 80 wt. %, or from 25 to 75 wt. %, or from 25 to 70 wt. %, or from 30 to 65 wt. %, or from 35 to 60 wt. %, or from 40 to 55 wt. %, or from 45 to 50 wt. % of diamond solvent-catalyst based on a total weight of the diamond reactive material, or any discrete value or range therebetween. In some embodiments, the diamond reactive materials disclosed herein contain at least 3 wt. %, or at least 5 wt. %, or at least 10 wt. %, or at least 15 wt. %, or at least 20 wt. %, or at least 25 wt. %, or at least 30 wt. %, or at least 35 wt. %, or at least 40 wt. %, or at least 45 wt. %, or at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 95 wt. %, or at least 99 wt. %, or 100 wt. % of diamond solvent-catalyst based on a total weight of the diamond reactive material.

In some embodiments, less than an entirety of the opposing bearing surface includes the diamond reactive material, with the provision that a metal contact area of the opposing bearing surface includes diamond reactive material in at least one position along a contact path between the metal contact area and a diamond contact area of the bearing surface. For example, the opposing bearing surface may include a section of diamond reactive material adjacent a section of another material that is not a diamond reactive material.

In some embodiments, the diamond reactive material is a superalloy including, but not limited to, an iron-based superalloy, a cobalt-based superalloy, or a nickel-based superalloy.

In certain embodiments, the diamond reactive material is not and/or does not include (i.e., specifically excludes) so called “superhard materials.” As would be understood by one skilled in the art, “superhard materials” are a category of materials defined by the hardness of the material, which may be determined in accordance with the Brinell, Rockwell, Knoop and/or Vickers scales. Superhard materials are materials with a hardness value exceeding 40 gigapascals (GPa) when measured by the Vickers hardness test. The diamond reactive materials disclosed herein may be softer than a superhard material. For example, the diamond reactive materials disclosed herein may have a hardness value of less than 40 GPa, or less than 35 GPa, or less than 30 GPa, or less than 25 GPa, or less than 20 GPa, or less than 15 GPa, or less than 10 GPa, or less than 8 GPa, or less than 6 GPa, or less than 5 GPa, or less than 4 GPa, or less than 3 GPa, or less than 2 GPa, or less than 1 GPa when measured by the Vickers hardness test. The diamond reactive materials disclosed herein are softer than tungsten carbide (WC), which has a hardness of about 25 GPa. The diamond reactive materials disclosed herein include materials that are softer than tungsten carbide tiles, cemented tungsten carbide, and infiltrated tungsten carbide. The diamond reactive materials disclosed herein include materials that are softer than silicon carbide, silicon nitride, cubic boron nitride, and polycrystalline diamond. One skilled in the art would understand that hardness may be determined by different tests, including a Brinell scale test in accordance with ASTM E10-18; the Vickers hardness test in accordance with ASTM E92-17; the Rockwell hardness test in accordance with ASTM E18; and the Knoop hardness test in accordance with ASTM E384-17.

In some embodiments, the diamond reactive materials are in the form of hardfacings, coatings, or platings on another material, such that the diamond reactive material forms the opposing bearing surface. In such embodiments, the hardfacing, coating, or plating includes the diamond reactive material. In some such embodiment, the material underlying the hardfacing, coating, or plating is not a diamond reactive material. In other such embodiments, the material underlying the hardfacing, coating, or plating is a diamond reactive material (the same or different than the overlying hardfacing, coating, or plating).

In some embodiments, the opposing bearing surface has carbon applied thereto. In some such embodiments, the carbon is applied to the opposing bearing surface prior to engagement with the diamond bearing surface. For example, the opposing bearing surface may be saturated with carbon. Without being bound by theory, it is believed that such application of carbon reduces the ability of the diamond solvent-catalyst in the opposing bearing surface to attract carbon through graphitization of the surface of the polycrystalline diamond element. That is, the carbon that is applied to the opposing bearing surface functions as a sacrificial layer of carbon. In such embodiments, the opposing bearing surface that underlies the carbon includes the diamond reactive material.

In some embodiments, the opposing bearing surface is a treated surface in accordance with the treatments disclosed in U.S. Pat. No. 11,035,407. For example, the opposing bearing surface (also referred to as the opposing engagement surface) may be hardened, such as via cold working and work hardening processes including burnishing and shot peening; and/or heat-treating processes including through hardening, case hardening, and subzero, cryogenic, deep-freezing treatments. Also, the opposing bearing surface may be plated and/or coated, such as via electroplating, electroless plating, including chromium plating, phosphating, vapor deposition, including physical vapor deposition (PVD) and CVD; or anodizing. Also, the opposing bearing surface may be cladded, such as via roll bonding, laser cladding, or explosive welding.

In some embodiments, the opposing bearing surface has a surface roughness of from 0.5 to 2,000 μin Ra, or from 1 to 1,900 pin Ra, or from 5 to 1,500 pin Ra, or from 10 to 1,200 pin Ra, or from 50 to 1,000 pin Ra, or from 100 to 800 pin Ra, or from 200 to 600 pin Ra. In some embodiments, the opposing bearing surface has a surface roughness that is equal to, less than, or greater than the diamond bearing surface.

### Engaged Bearing Surfaces

In some embodiments, the motors disclosed herein are designed to have interfacing contact between the diamond bearing surface and the metal bearing surface within a bearing assembly. Interfacing contact between the bearing surfaces includes engaging the diamond bearing surface in contact (e.g., sliding contact) with the opposing bearing surface. As used herein, “engagement surface” or “bearing surface” refers to the surface of a material or component (e.g., the surface of polycrystalline diamond or the surface of a diamond reactive material) that is positioned and arranged within a bearing assembly such that, in operation of the bearing assembly, the “engagement surface” or “bearing surface” is positioned and/or available to interface the contact between two components to bear load (e.g., radial and/or axial load). In some embodiments, the diamond bearing surface disclosed herein is in direct contact with the opposing metal bearing surface without a fluid film therebetween (i.e., boundary lubrication). In other embodiments, a fluid film is positioned and/or develops between the diamond bearing surface and the opposing metal bearing surface such that the bearing surfaces are not directly in contact with one another, but are engaged through the fluid film (i.e., hydrodynamic lubrication). The contact between the diamond bearing surface and opposing metal bearing surface may be between (or a mixture of) or may vary between direct contact and fluid film (i.e., mixed boundary lubrication).

### Bearing Assemblies

In some embodiments, the motor is designed to have a journal bearing or an angular contact bearing (e.g., a conical bearing or spherical bearing). The bearing assemblies are not limited to the specific exemplary bearing assemblies discussed herein. Some embodiments include a bearing assembly that includes one or more of the diamond bearing surfaces engaged with one or more of the opposing metal bearing surfaces. The diamond bearing surfaces are in sliding engagement with the opposing metal bearing surfaces. Depending on the desired configuration of the bearing assembly, the sliding engagement between the diamond bearing surface and the opposing metal bearing surface can be a flat surface interface, a curved (e.g., cylindrical) surface interface, or a combination of flat and curved surface interfaces.

The coefficient of friction (CoF) exhibited by the engagement between the diamond bearing surfaces and the opposing metal bearing surfaces disclosed herein can be less than 0.1, 0.09 or less, 0.08 or less, 0.07 or less, 0.06 or less, 0.05 or less, 0.04 or less, 0.03 or less, 0.02 or less, or 0.01 or less. The CoF exhibited by the engagement between the diamond bearing surfaces and the opposing metal bearing surfaces disclosed herein ranges from 0.01 to 0.09, or 0.01 to 0.07, or 0.01 to 0.05, or 0.01 to 0.03, or any range or discrete value therebetween.

In some embodiments, an entirety of the surface area of opposing bearing surface is engaged with less than an entirety of the surface area of each of the diamond bearing surfaces. The portion of a diamond bearing surface that the opposing bearing surface is engaged with during operation of bearing assembly is the “diamond contact area” of that diamond bearing surface. The opposing engagement surface(s) may be slidingly engaged with the diamond engagement surface(s) of the bearing assembly along a diamond contact area of the diamond engagement surface. As used herein, “diamond contact area” refers to the portion of the surface area of the diamond engagement surface that contacts the opposing engagement surface during operation of the bearing. That is, the diamond engagement surface is the surface area of the diamond bearing element that is available for contact as a bearing surface, and the diamond contact area is the portion of the surface area of the diamond engagement surface that contacts (directly or through a fluid film) the opposing engagement surface during operation of the bearing. In some embodiments, the diamond contact area has a surface area that is less than a surface area of the diamond engagement surface. That is, less than an entirety of the diamond engagement surface forms the diamond contact area of the diamond bearing. In some embodiments, such as in a radial bearing, the diamond contact area is a radial contact area. That is, the sliding movement of the opposing engagement surface along the diamond contact area on the diamond engagement surface is a radial, rotating movement along the diamond contact area. In other embodiments, the diamond contact area is an axial contact area. That is, the sliding movement of the opposing engagement surface on the diamond engagement surface is an axial movement along the diamond contact area. In some embodiments, the diamond contact area is both a radial and axial diamond contact area.

In some embodiments, the diamond bearings disclosed herein have discontinuous diamond bearing surfaces. For example, a bearing component (e.g., a radial journal bearing) having diamond bearing surfaces may be coupled with an opposing bearing component (e.g., a shaft) having an opposing bearing surface such that the opposing bearing is slidingly engaged with the diamond bearing surfaces along a diamond contact area of the diamond bearing surfaces, and such that the diamond bearing surfaces are “discontinuous” along the diamond contact area. As used herein, diamond bearing surfaces are “discontinuous surface” along a diamond contact area when the diamond bearing surfaces are interrupted by at least one boundary edge throughout the diamond contact area. That is, during operation, while the opposing bearing surface slides along the diamond contact area, the opposing bearing surface slides on, along, or in contact with at least one boundary edge of the diamond bearing surfaces.

While the diamond engagement surfaces disclosed herein include discontinuous diamond bearing surfaces, the diamond engagement surfaces may be treated, prepared, and/or arranged to reduce edge contact between the diamond engagement surfaces and the opposing engagement surfaces. In some embodiments, the boundary edges of the diamond bearing surfaces are beveled edges, radiused edges, or honed edges, such that the opposing bearing surface can slide over the boundary edges without (or with reduced) gouging as a result of edge contact with the boundary edges of the diamond. A performance criterion, in some embodiments, is that the diamond bearing elements are configured and positioned in such a way as to minimize or preclude edge contact with the opposing bearing surface. In some aspects, the diamond bearing elements are subjected to edge radius treatment to facilitate avoidance of edge contact with the opposing bearing surface. In some embodiments, the edge geometry of the diamond bearing element is subjected to a surface roughness reduction process, such as lapping and/or polishing. In other embodiments, the edge geometry of the polycrystalline diamond element is not subjected to a surface roughness reduction process. The diamond bearing surfaces disclosed herein may be planar, convex, or concave.

In some embodiments, adjacent diamond bearing elements are positioned relative to one another such that the diamond bearing elements are contiguous or nearly contiguous, and such that the adjacent diamond bearing surfaces thereof are flush or nearly flush with each other at the adjoining boundary edges thereof. For example, adjacent diamond bearing surfaces can be positioned relative to one another such that the diamond bearing surfaces are flush or nearly flush with each other at the boundary edges therebetween. The provision of flush or nearly flush adjacent bearing surfaces, in combination with lapping and/or polishing of the diamond bearing surfaces, provides an array of multiple diamond bearing surfaces that, together, provide a contiguous or near contiguous bearing contact path for engagement with the metal bearing surface. The multiple diamond bearing surfaces are lapped and/or polished and arranged relative to one another such that the multiple diamond bearing surfaces, together, form a “substantially continuous surface.” As used herein, multiple (or a plurality of) diamond bearing surfaces form a “substantially continuous surface” along the diamond contact areas of the diamond bearing surfaces when the diamond bearing surfaces are only interrupted by boundary edges throughout the diamond contact area where adjacent diamond bearing surfaces are flush or nearly flush. For example, during operation, while the opposing metal bearing surface slides along the diamond contact area, the opposing metal bearing surface slides on, along, and/or in contact only with boundary edges of the diamond bearing surfaces where the adjacent diamond bearing surfaces are flush or nearly flush. In some such embodiments, the adjacent diamond bearing elements are not spaced apart, and are in contact with one another, such that the bearing assembly includes an array of diamond bearing elements that are discrete but in contact with one another.

In some embodiments, edge treatment (e.g., radiused edges) of the boundary edges of the diamond bearing surfaces, in combination with lapping and/or polishing of the diamond bearing surfaces and relative positioning of the diamond bearing surfaces, may provide an array of multiple diamond bearing surfaces that, together, provide a bearing contact path for engagement with the metal bearing surface. For example, during operation, while the opposing metal bearing surface slides along the diamond contact area, the opposing metal bearing surface slides on, along, or in contact only with boundary edges of the diamond bearing surfaces that have been subjected to edge treatment (e.g., that are beveled, radiused, chamfered).

### Methods of Making the Diamond Surfaces

In some embodiments, the diamond bearing and engagement surfaces disclosed herein are made by a high-pressure and high-temperature process (HPHT diamonds). In some embodiments, the diamond surfaces disclosed herein are made by CVD or PVD of a diamond layer. The thickness of the diamond layer that has the diamond surfaces may be 0.200″ or less, or 0.150″ or less, or 0.100″ or less, or 0.09″ or less, or 0.08″ or less, or 0.07″ or less, or 0.06″ or less, or 0.05″ or less, or 0.04″ or less, or 0.03″ or less, or 0.02″ or less, 0.010″ or less. The thickness of the diamond layer that has the diamond surface may be from 0.010″ to 0.200″, from 0.02″ to 0.150″, from 0.03″ to 0.100″, from 0.04″ to 0.09″, from 0.05″ to 0.08″, from 0.06″ to 0.07″, or any range or discrete value therebetween. For example, when the diamond layer is made via CVD or PVD, the thickness of the diamond layer that has the diamond surface may be 0.010″ or less, and when the diamond layer is made by a high-pressure and high-temperature process the thickness of the diamond layer that has the diamond surface may be 0.200″ or less. In some embodiments, the diamond is leached, un-leached, or leached and backfilled. As an example, to make a diamond layer using the CVD process, seed diamond particles are attached to a substrate and then placed in a chamber under conditions sufficient to promote the crystalline growth of the seed diamond particles.

### APPLICATIONS

While the motor and bearing assemblies disclosed herein are descried as being used in downhole drilling motors, the method disclosed herein may be applied to other applications as well. In some embodiments, the method, or a variation thereof, can be applied to design a roller ball assembly in accordance with U.S. Pat. No. 11,014,759; a tubular protection in accordance with U.S. Pat. No. 11,225,842 or U.S. Pat. No. 11,603,715; or a linear bearing in accordance with U.S. Pat. No. 11,371,556.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for designing a motor, the method comprising:
determining an application for the motor;
determining a type of power section for the motor;
determining a transmission type for the motor;
determining a type bearings for use in the motor, wherein the determined type of bearings include at least one diamond-on-metal bearing; and
reviewing connection threads and stresses in the motor.

2. The method of claim 1, further comprising determining to include a package in the motor, wherein the packing comprises a sensor package, a communications package, an actuator package, or combinations thereof.

3-6. (canceled)

7. The method of claim 2, further comprising selecting a location on the motor for the package, wherein the selected location is on a bearing housing of the motor between two bearing arrays of the motor.

8. The method of claim 1, wherein determining the application for the motor comprises determining a motor type, wherein determining the motor type comprises determining the motor to be a motor assist rotary steerable type motor or a bent housing directional drilling type motor.

9. (canceled)

10. (canceled)

11. The method of claim 8, further comprising determining a geometry of the housing, wherein determining the geometry comprises selecting a standard, compound geometric guidance positioner, selecting a dynamic lateral pad, or combinations thereof.

12. (canceled)

13. The method of claim 11, further comprising selecting a bend angle, wherein the selected bend angle is no angle, a standard angle, a low-bend angle, or a micro-bend angle.

14. (canceled)

15. The method of claim 13, wherein the available bend angles for the motor design are undesirable, the method further comprising:
reconfiguring the motor design by repeating prior method steps until a desirable bend angle is achieved.

16. The method of claim 36, wherein locking-in the bit-to-bend length for the motor comprises determining that the bit-to-bend length is not appropriate for expected or desired build angle, the method further comprising reconfiguring the motor design until a desirable bit-to-bend length is achieved.

17. (canceled)

18. (canceled)

19. The method of claim 1, further comprising providing a custom batch of license agreements based on the selections and determinations at each step of the method.

20. The method of claim 1, wherein at least some of the steps are computer implemented including computer modeling of the motor.

21. The method of claim 1, wherein each step of the method at least partially affects subsequent steps of the method, and wherein the method is an iterative method, the method including repeating prior steps to obtain desired results in a current step.

22. (canceled)

23. The method of claim 1, wherein the motor is a downhole drilling motor.

24. The method of claim 1, wherein determining the type of power section comprises determining that the power section is a high-speed/low-torque power section or a low-speed/high-torque power section.

25. (canceled)

26. The method of claim 1, wherein determining transmission type comprises determining the transmission comprises a flex shaft or a mechanically flexible or articulating coupling.

27. (canceled)

28. The method of claim 1, wherein determining transmission type comprises determining the transmission comprises a mechanical coupling that is a diamond-on-metal coupling.

29. (canceled)

30. (canceled)

31. The method of claim 1, wherein determining the transmission type comprises selecting the transmission to be suitable for expected torques and loads on the motor.

32. The method of claim 1, wherein determining the type of bearing comprises determining that the bearing is a diamond-on-metal thrust bearing, a diamond-on-metal radial bearing, a diamond-on-metal angular contact bearing, or combinations thereof.

33. (canceled)

34. (canceled)

35. A method for designing a downhole directional drilling motor, the method comprising:
determining a motor type to be a motor assist rotary steerable type motor or a bent housing directional drilling type motor determining a type of power section for the motor including determining that the power section is a high-speed/low-torque power section or a low-speed/high-torque power section;
determining a transmission type for the motor including selecting the transmission to be suitable for expected torques and loads on the motor and determining the transmission comprises a flex shaft or a mechanical coupling;
determining a type bearing for use in the motor, wherein the bearing is a diamond-on-metal bearing;
reviewing connection threads and stresses in the motor;
locking-in a bit-to-bend length for the motor including determining if the bit-to-bend length is appropriate for expected or desired build angle; and
iteratively repeating steps of the method to obtain desired results.

36. The method of claim 1, further comprising locking-in a bit-to-bend length for the motor.

37. A method for designing a motor, the method comprising:
determining an application for the motor, including determining a motor type to be a motor assist rotary steerable type motor or a bent housing directional drilling type motor;
determining a type of power section for the motor including determining that the power section is a high-speed/low-torque power section or a low-speed/high-torque power section;
determining a transmission type for the motor;
determining a type bearing for use in the motor, wherein the bearing includes a conical, diamond-on-metal bearing;
reviewing connection threads and stresses in the motor;
determining to include a package in the motor, wherein the packing comprises a sensor package, a communications package, an actuator package, or combinations thereof;
locking-in a bit-to-bend length for the motor; and
providing a custom batch of license agreements based on the selections and determinations at each step of the method.
